(19) United States
(12) Patent Application Publication
(10) Pub. No.: US 2007/0162935 A1
(43) Pub. Date: Jul. 12, 2007

(54) Program search device

(75) Inventor: Atsushi Matsutani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/586,922

(22) PCT Filed: Feb. 3, 2005
(86) PCT No.: PCT/JP05/01976

§ 371 Date: Jul. 24, 2006

(30) Foreign Application Priority Data
Feb. 10, 2004 (JP) 2004-033689

(51) Int. Cl. H04N 5/445; G06F 3/00; G06F 13/00

(52) U.S. Cl. 725/52; 725/45; 725/53

(57) ABSTRACT

A keyword showing the user's preference in radio programs is registered, and the number of hits of the above keyword in each radio program is totalized based on on-air information and now-on-air information being broadcast content information. The number of hits of the keyword is displayed on a display 26. Thereby, the user can recognize that which radio program is a radio program having a strong tendency to provide information concerning the keyword. Thus, a radio program matching to the user's preference can be shown to the above user.

### TECHNICAL FIELD

The present invention relates to a program search system, and is suitably applicable when in searching for a broadcast program matching to the user's preference and showing the program to the user.

### BACKGROUND ART

Heretofore, as a method for confirming information showing the broadcast contents of radio broadcasting and television broadcasting (that is information including program information such as the title of a broadcast program and the cast, and musical composition information such as the title and the artist of a musical composition broadcasted in the broadcast program, and is hereinafter also referred to as broadcast content information), a method for confirming it by referring to the home page of a broadcast content information provision server that provides broadcast content information, and a method for confirming it by purchasing an information book or the like in that the broadcast content information appears are generally used.

Further, a method that when the user had interest in a musical composition being broadcasted in a broadcast program (for example, a radio program), the user stores the time in the portable terminal, and a predetermined server searches for broadcast content information concerning the above broadcast program and musical composition from a database based on the time and provides this to the above user has been proposed (for example, see Patent Document 1).

Patent Document 1—Japanese Patent Laid-Open No. 2000-339345.

By the way, the aforementioned broadcast content information is information by the broadcasting time and date of each broadcast program by each broadcasting station, and the amount of information is huge. Therefore, it is difficult that the user finds a broadcast program matching to his/her preference from broadcast content information appearing in a home page, an information book or the like.

Moreover, in the case where when the user had interest in a musical composition being broadcasted in a radio program, the user stores the time in the portable terminal, and broadcast content information concerning the above radio program and musical composition is searched based on the time and is provided to the user, only the broadcast content information concerning the radio program that the user was listening can be provided. That is, in this case, on radio programs that the user does not listen, even if there was a radio program in that the musical composition that the user had interest was being broadcasted (that is, a radio program matching to the user's preference), broadcast content information concerning this radio program cannot be provided to the above user.

In a conventional method, as the above, there has been a problem that it is hard to say that a broadcast program matching to the user's preference can be shown to the above user.

### DISCLOSURE OF INVENTION

Considering the above points, the present invention has been done and is proposing a program search system, a program search method and a program search program that can show a program matching to the user's preference to the above user.

To obviate such problem, according to a program search system of the present invention, keyword registration means for registering a keyword to show the user's preference in broadcast programs, communication means for receiving broadcast content information including the titles of broadcast programs that will be broadcasted by one or more broadcasting stations, and detection means for detecting the appearance frequency of the keyword by the broadcast programs, in the broadcast content information received by the communication means are provided.

Further, in a program search system according to the present invention, a storage medium for storing broadcast content information including the broadcasting time and date and the titles of broadcast programs that will be broadcasted by one or more broadcasting stations by the above broadcast programs, receiving means for receiving search condition information specifying at least either one of the broadcasting period, the title and the broadcasting station name of the broadcast program as a search condition, and a keyword showing the user's preference in broadcast programs, from an external device, search means for searching for broadcast content information corresponding to the search condition from the storage medium, based on the search condition information received by the receiving means, detection means for detecting the appearance frequency of the keyword by the broadcast programs, in the broadcast content information that was obtained as the search result by the search means, and transmission means for transmitting information based on the appearance frequency of the keyword by the broadcast programs detected by the detection means to the external device are provided.

In this manner, a keyword showing the user's preference in broadcast programs is registered, and the appearance frequency of the above keyword is detected by the broadcast programs based on broadcast content information. The appearance frequency of the above keyword in each broadcast program is displayed on a predetermined display section. Thus, the user can recognize that which broadcast program is a broadcast program having a strong tendency to provide information concerning the keyword.

Further, in a program search method according to the present invention, the keyword registration step of registering a keyword showing the user's preference in broadcast programs, the communication step of receiving broadcast content information including the titles of the broadcast programs that will be broadcasted by one or more broadcasting stations, and the detection step of detecting the appearance frequency of the keyword by the broadcast programs, in the broadcast content information received in the communication step are provided.

In this manner, a keyword showing the user's preference in broadcast programs is registered, and the appearance frequency of the above keyword is detected by the broadcast programs based on broadcast content information. The appearance frequency of the above keyword in each broadcast program is displayed on a predetermined display section. Thus, the user can recognize that which broadcast program is a broadcast program having a strong tendency to provide information concerning the keyword.

Further, a program search program according to the present invention makes an information processing unit execute the keyword registration step of registering a keyword showing the user's preference in broadcast programs, the communication step of receiving broadcast content information including the titles of the broadcast programs that will be broadcasted by one or more broadcasting stations, and the detection step of detecting the appearance frequency of the keyword by the broadcast programs, in the broadcast content information received in the communication step.

In this manner, a keyword showing the user's preference in broadcast programs is registered, and the appearance frequency of the above keyword is detected by the broadcast programs based on broadcast content information. The appearance frequency of the above keyword in each broadcast program is displayed on a predetermined display section. Thus, the user can recognize that which broadcast program is a broadcast program having a strong tendency to provide information concerning the keyword.

According to the present invention, a keyword showing the user's preference in broadcast programs is registered, and the appearance frequency of the above keyword is detected by the broadcast programs based on broadcast content information. The appearance frequency of the above keyword in each broadcast program is displayed on a predetermined display section. Thus, the user can recognize that which broadcast program is a broadcast program having a strong tendency to provide information concerning the keyword. Thereby, a program search system, a program search method and a program search program that can show a broadcast program matching to the user's preference to the above user can be realized.

### BRIEF DESCRIPTION OF DRAWINGS

FIG. 1 is a schematic diagram showing the configuration of a broadcast content information provision system according to a first embodiment.

FIG. 2 is a block diagram showing the configuration of a broadcast content information provision server.

FIG. 3 is a schematic diagram showing the configuration of a broadcast content information database.

FIG. 4 is a schematic diagram showing the update of broadcast content information in a table of program being broadcasted.

FIG. 5 is a schematic diagram showing the addition of broadcast content information in a table of already-broadcasted musical compositions.

FIG. 6 is a schematic diagram showing the addition of broadcast content information in a table of already-broadcasted programs.

FIG. 7 is a schematic diagram showing the contents of on-air information.

FIG. 8 is a block diagram showing the circuit configuration of a client terminal.

FIG. 9 is a flowchart showing first preference program display processing.

FIG. 10 is a schematic diagram showing a preference program display screen (radio program).

FIG. 11 is a flowchart showing second preference program display processing.

FIG. 12 is a flowchart showing third preference program display processing.

FIG. 13 is a block diagram showing the configuration of a hard disk recorder according to a second embodiment.

FIG. 14 is a schematic diagram showing a television program listings screen (1).

FIG. 15 is a flowchart showing preference program display processing according to the second embodiment.

FIG. 16 is a schematic diagram showing a preference program display screen (television program).

FIG. 17 is a schematic diagram showing a television program listings screen (2).

FIG. 18 is a schematic diagram showing a display example of preference program information (1).

FIG. 19 is a schematic diagram showing a display example of preference program information (2).

### BEST MODE FOR CARRYING OUT THE INVENTION

Embodiments of the present invention will be described in detail with reference to the accompanying drawings.

### (1) First Embodiment

(1-1) Configuration of Broadcast Content Information Provision System

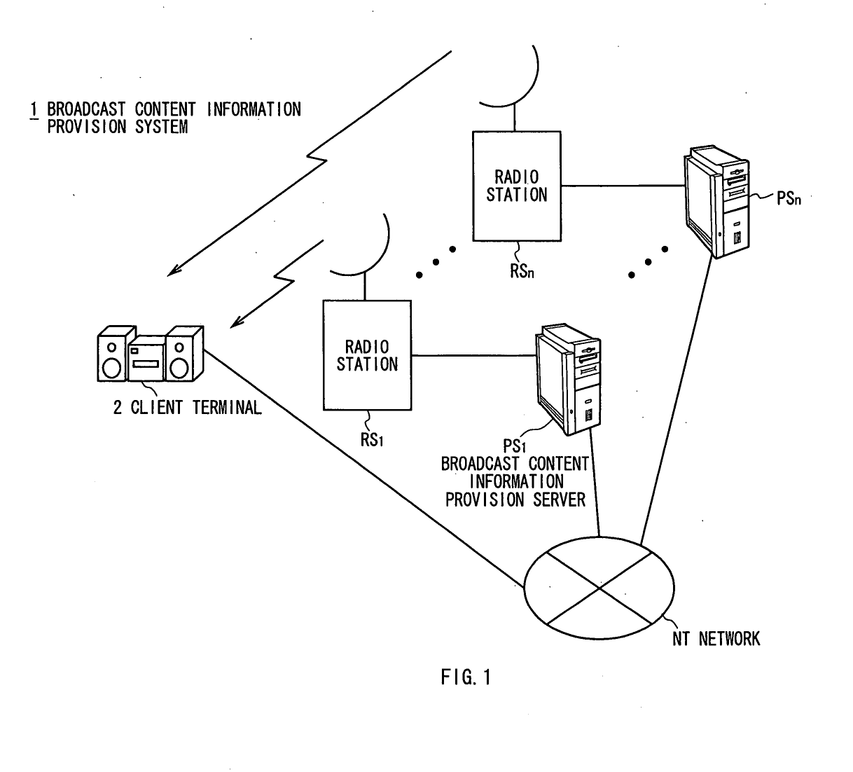

Referring to FIG. 1, the reference numeral 1 shows a broadcast content information provision system according to a first embodiment as a whole. A client terminal 2 receives a radio broadcast wave respectively transmitted from one or more radio stations RS (RS₁-RSₙ).

Further, in the radio station RS (RS₁-RSₙ), a broadcast content information provision server PS (PS₁-PSₙ) for respectively providing broadcast content information (the contents will be described later) of the own station to the client terminal 2 via a network NT such as the Internet is connected by a leased line. The present broadcasting state (the start and the end of a radio program, and the start and the end of a musical composition broadcasted in the radio program) is notified to the broadcast content information provision server PS (PS₁-PSₙ).

Then, if accepting an acquisition request of broadcast content information from the client terminal 2 via the network NT, the broadcast content information provision server PS (PS₁-PSₙ) transmits the broadcast content information to the client terminal 2 via the network NT responding to the acquisition request.

(1-2) Circuit Configuration of Broadcast Content Information Provision Server

Next, the circuit configuration of the broadcast content information provision server PS (PS₁-PSₙ) will be described. Note that, because the circuit configurations of the broadcast content information provision servers PS₁-PSₙ in this embodiment are the completely same, here only the circuit configuration of the broadcast content information provision server PS₁ will be described as an example. The description of the broadcast content information provision servers PS₂-PSₙ will be omitted.

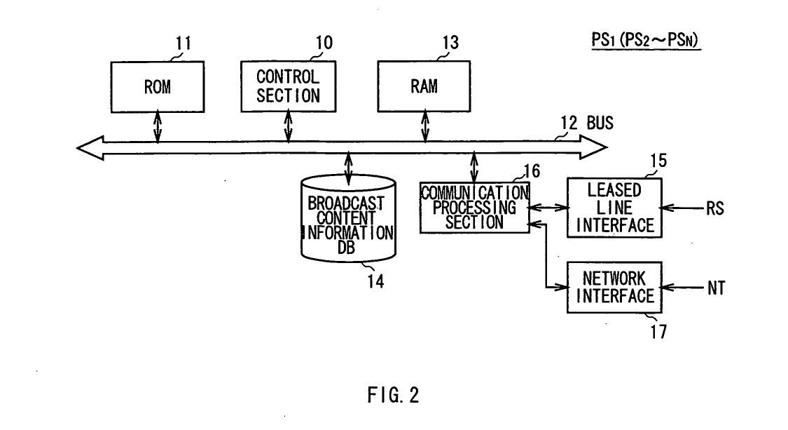

As shown in FIG. 2, in the broadcast content information provision server PS₁, a control section 10 having a central processing unit (CPU) configuration reads out various programs such as a basic program and application programs that have been previously stored in a read only memory (ROM) 11 to a random access memory (RAM) 13 via a bus 12, and controls the entire server according to these various programs, and also executes predetermined operation processing or the like.

This broadcast content information provision server PS₁ is managed and is run by the radio station RS₁ connected by the leased line, and broadcast content information concerning the radio broadcasting broadcasted by the above radio station RS₁ is managed by a broadcast content information database 14.

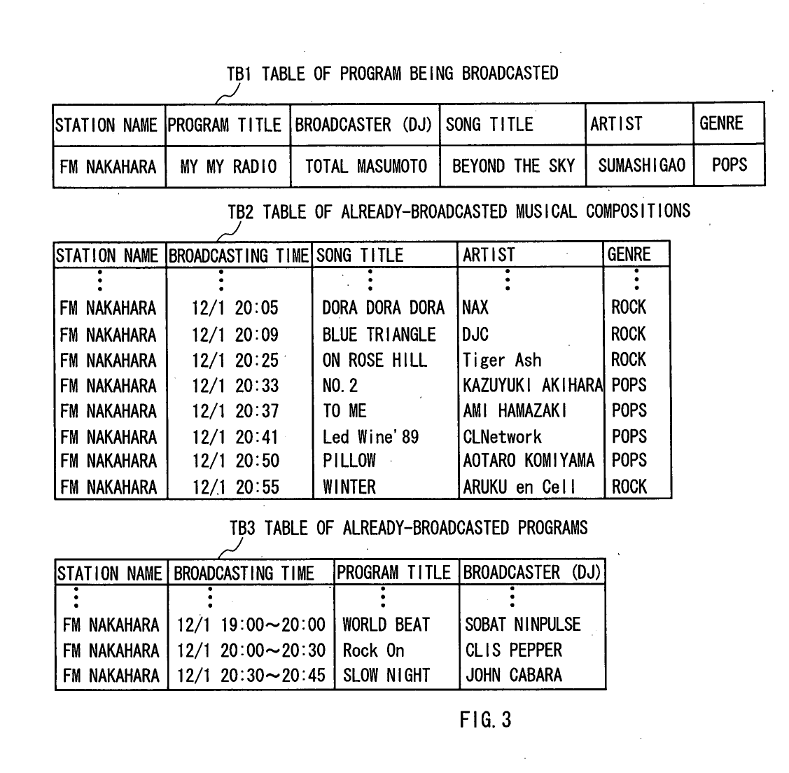

Here, the configuration of the broadcast content information database 14 is shown in FIG. 3. The broadcast content information database 14 is composed of plural tables for managing broadcast content information (a table of program being broadcasted TB1, a table of already-broadcasted musical compositions TB2 and a table of already-broadcasted programs TB3).

In the table of program being broadcasted TB1, broadcast content information composed of the station name of the radio station RS₁ connected to the broadcast content information provision server PS₁, the title of a radio program being broadcasted now by the above radio station RS₁, the title of a musical composition being broadcasted now in the above radio program, the artist of the above musical composition and the genre of the above musical composition has been stored.

That is, in the table of program being broadcasted TB1, only the broadcast content information concerning the radio program and the musical composition being broadcasted now is stored.

In the table of already-broadcasted musical compositions TB2, broadcast content information composed of the station name of the radio station RS₁, the time (the date and the start time) when a musical composition was broadcasted in a radio program by the above radio station RS₁, the title of the above musical composition, the artist of the above musical composition and the genre of the above musical composition has been stored.

That is, in the table of already-broadcasted musical compositions TB2, the broadcast content information concerning the musical compositions that were broadcasted in the radio programs is stored.

And in the table of already-broadcasted programs TB3, broadcast content information composed of the station name of the radio station RS₁, the broadcasting time (the date, the start time and the end time) of a radio program that was broadcasted by the above radio station RS₁, the title of the above radio program, and the name of the broadcaster of the above radio program (disk jockey (DJ)) has been stored.

That is, in the table of already-broadcasted programs TB3, the broadcast content information concerning the radio programs that were broadcasted is stored.

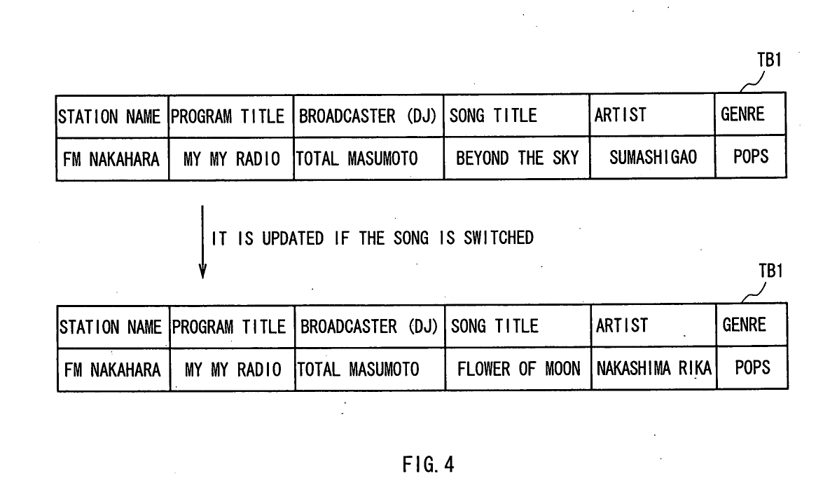

Practically, if the present broadcasting state (the start and the end of the radio program, and the start and the end of the musical composition broadcasted in the radio program) is notified from the radio station RS₁ sequentially via a leased line interface 15 and a communication processing section 16, as shown in FIG. 4, the control section 10 (FIG. 2) of the broadcast content information provision server PS₁ updates the table of program being broadcasted TB1 in the broadcast content information database 14, according to the broadcasting state.

Specifically, the broadcast content information stored in the table of program being broadcasted TB1 is updated to the latest broadcast content information, at the timing of when the radio program finished and was switched to the next radio program, and the musical composition that had been broadcasted in the radio program was switched to the next musical composition.

Accordingly, in the table of program being broadcasted TB1, almost real-time broadcast content information matching to the present broadcasting state is stored.

Responding to an acquisition request from the client terminal 2, the control section 10 transmits this real-time broadcast content information thereinafter, this is referred to as now-on-air information) stored in the table of program being broadcasted TB1 to the client terminal 2, sequentially via the communication processing section 16 and a network interface 17.

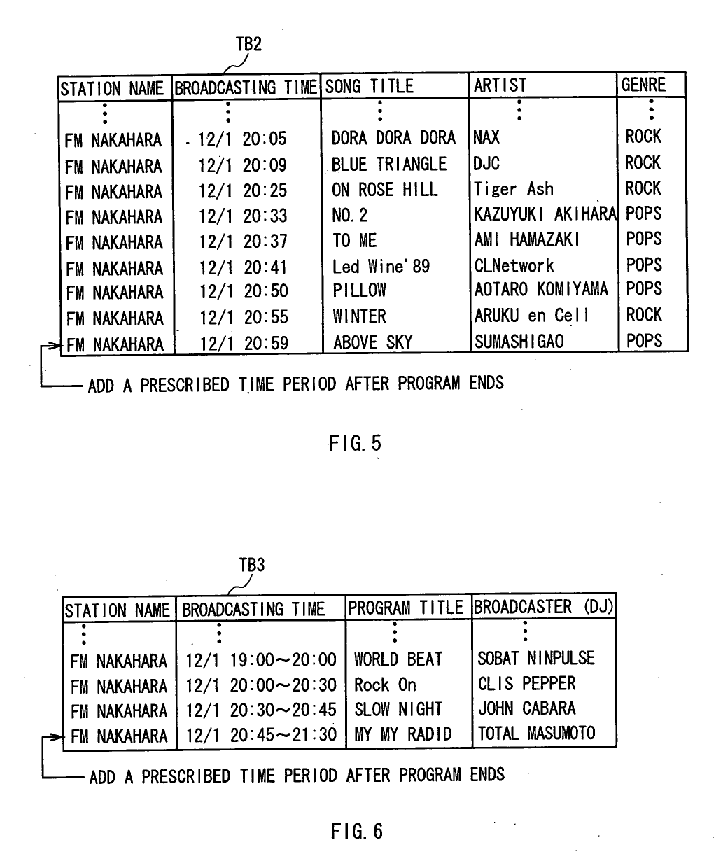

Further, after a predetermined time (for example, a few minutes) passed after the broadcasting of the musical composition being broadcasted in the radio program finished, as shown in FIG. 5, the control section 10 adds broadcast content information concerning the above musical composition to the table of already-broadcasted musical compositions TB2.

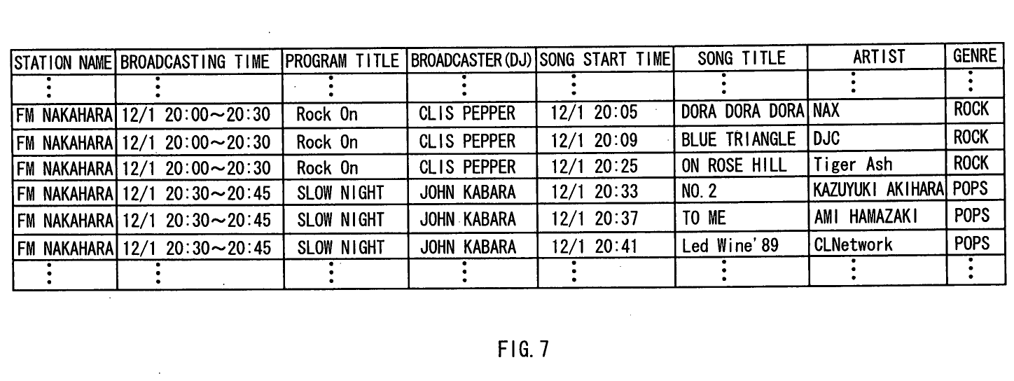

Further, after a predetermined time (for example, a few minutes) passed after the broadcasting of the radio program finished, as shown in FIG. 6, the control section 10 adds broadcast content information concerning the above radio program to the table of already-broadcasted programs TB3.

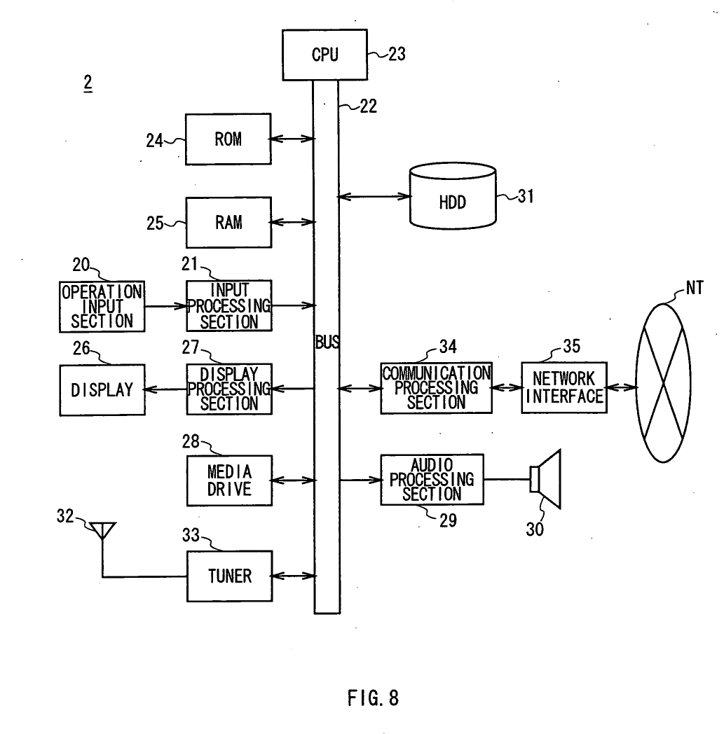

Also, by connecting the broadcasting time in the table of already-broadcasted musical compositions TB2 with the broadcasting time in the table of already-broadcasted programs TB3, as shown in FIG. 7, the control section 10 generates broadcast content information concerning the radio program and the musical composition broadcasted in the above radio program (hereinafter, this is referred to as on-air information).

The on-air information is broadcast content information concerning each radio program and the musical composition broadcasted in the above each radio program as the above. Therefore, by accumulating the on-air information, the accumulated on-air information becomes list information showing that which musical composition was broadcasted in which radio program.

Responding to an acquisition request from the client terminal 2, the control section 10 transmits this on-air information to the client terminal 2, sequentially via the communication processing section 16 and the network interface 17.

In this manner, the broadcast content information provision server PS₁ stores and manages the broadcast content information concerning the radio programs broadcasted by the radio station RS₁, and also generates the now-on-air information concerning the radio program and musical composition being broadcasted now and the on-air information concerning the radio program and musical composition already broadcasted based on the broadcast content information, and provides this to the above client terminal 2.

Similarly, also the broadcast content information provision servers PS₂-PSₙ store and manage broadcast content information of radio programs and musical compositions broadcasted by the respectively-corresponding radio stations RS₂-RSₙ, and also provides now-on-air information and on-air information to the client terminal 2.

(1-3) Circuit Configuration of Client Terminal

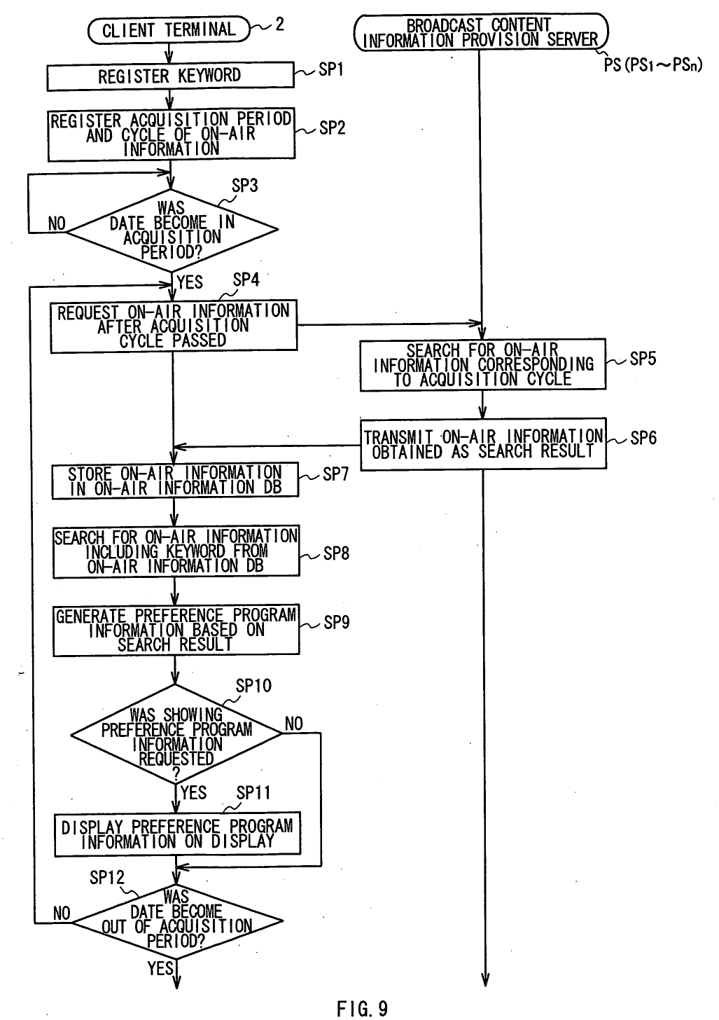

Next, the circuit configuration of the client terminal 2 will be described. As shown in FIG. 8, if an operation input section 20 formed by various operation buttons provided on the surface of the main body of the client terminal 2 and a remote controller (not shown) is operated by the user, the client terminal 2 recognizes this in the above operation input section 20, and transmits an operation input signal corresponding to the above operation to an input processing section 21.

The input processing section 21 performs predetermined input processing on the supplied operation input signal to convert the above operation input signal into an operation command, and supplies this to a CPU 23 via a bus 22.

The CPU 23 reads out various programs such as a basic program and application programs previously stored in a ROM 24 to a RAM 25 via the bus 22, and controls the entire client terminal 2 according to these various programs, and also executes predetermined operation processing and various processing corresponding to the operation command supplied from the input processing section 21.

A display 26 is a display device such as a liquid crystal display, and there are a case directly attached to the surface of the main body and a case externally provided. If a processing result by the CPU 23 or various video data is supplied via the display processing section 27 as a video signal, an image based on the above video signal is displayed.

The media drive 28 is a drive for reading out and reproducing for example contents data recorded in a compact disc (CD), and contents data recorded in a Memory Stick (registered trademark) being a flash memory or the like. If the contents data is video data, the media drive 28 transmits this to the display processing section 27 via the bus 22, and if it is audio data, the media drive 28 transmits this to an audio processing section 29.

The display processing section 27 performs digital-to-analog conversion processing on the video data supplied via the bus 22, and supplies thus obtained video signal to the display 26, so that an image based on the above video signal is displayed on the display 26.

On the other hand, the audio processing section 29 performs digital-to-analog conversion processing on the audio data supplied via the bus 22, and transmits thus obtained audio signal to a two-channel speaker 30, so thapreferencereo sound based on the above audio signal is emitted from the speaker 30.

Further, the CPU 23 also can store contents data in a hard disk drive 31 as a contents file, by transmitting the contents data read by the media drive 28 to the hard disk drive 31 via the bus 22.

In this connection, also the contents file stored in the hard disk drive 31 can be read out from the hard disk drive 31 as contents data, and can be outputted from the display 26 and the speaker 30.

An antenna 32 receives radio broadcast waves transmitted from the radio stations RS (RS₁-RSₙ), and transmits them to a tuner 33 being an AM/FM tuner.

The tuner 33 extracts a radio broadcast signal for example at a frequency corresponding to the radio station RS₁ that was specified via the operation input section 20, from the radio broadcast waves received via the antenna 32 under the control of the CPU 23, demodulates it, and outputs thus obtained audio signal from the speaker 30 sequentially via the bus 22 and the audio processing section 29.

Thereby, the user can listen to the program sound of a radio program broadcasted by the radio station RS₁.

Further, the CPU 23 can access the broadcast content information provision server PS (PSₙ-PSₙ) on a network NT, by connecting to the network NT sequentially via a communication processing section 34 and a network interface 35.

Then, as the occasion demands, the CPU 23 transmits request information to request the acquisition of the aforementioned now-on-air information and on-air information to the broadcast content information provision server PS (PSₙ-PSₙ), and also receives the now-on-air information and on-air information transmitted from the above broadcast content information provision server PS (PS₁-PSₙ) responding to the above request information. Thereby, they can be recorded on the hard disk drive 31.

Furthermore, the client terminal 2 also can access a general service server on the network NT not shown in the drawings. The client terminal 2 transmits area information showing the area that the above client terminal 2 is being used to the general service server, so that a frequency of radio broadcasting that can be received in the area, the station name of the radio station RS (RS₁-RSₙ) broadcasting the above radio broadcasting, the address of the broadcast content information provision server PS (PS₁-PSₙ) managed by the above radio station RS (RS₁-RSₙ), and the like can be obtained from the general service server.

The client terminal 2 makes the user select some desired radio stations RS (RS₁-RSₙ), from among thus obtained receivable radio stations RS (RS₁-RSₙ), and records information in that the station names of these selected radio stations RS (RS₁-RSₙ), the frequencies and the addresses of the broadcast content information provision servers PS (PS₁-PSₙ) managed by the above selected radio stations RS (RS₁-RSₙ) are connected with each other (hereinafter, this is referred to as preset information) on the hard disk drive 31.

Thereby, the CPU 23 of the client terminal 2 tunes the tuner 33 to the frequency of the specified radio station RS₁, or accesses the broadcast content information provision server PS₁ managed by the radio station RS₁, only by making the user specify for example the station name of the radio station RS₁ from the preset information.

(1-4) Preference Program Display Function

The client terminal 2 in this embodiment has a preference program display function to search for a radio program matching to the user's preference (hereinafter, this is also referred to as a preference program) and show this to the user.

Practically, in the client terminal 2, as this technique to search for a preference program, if roughly classifying, there are a technique to search the on-air information stored and managed by the broadcast content information provision server PS (PS₁-PSₙ), and a technique to search the now-on-air information recorded and managed.

Further, among them, in the technique to search the on-air information, there is a case of searching by receiving the on-air information from the broadcast content information provision server PS (PS₁-PSₙ), and a case of making the broadcast content information provision server PS (PS₁-PSₙ) side search the on-air information for a preference program and receiving it.

Preference program display processing which corresponds to each technique and each case in the preference program display function will be described.

(1-4-1) First Preference Program Display Processing in the Case Where the Client Terminal 2 Receives On-Air Information from the Broadcast Content Information Provision Server PS (PS₁-PSₙ) and Search for a Preference Program

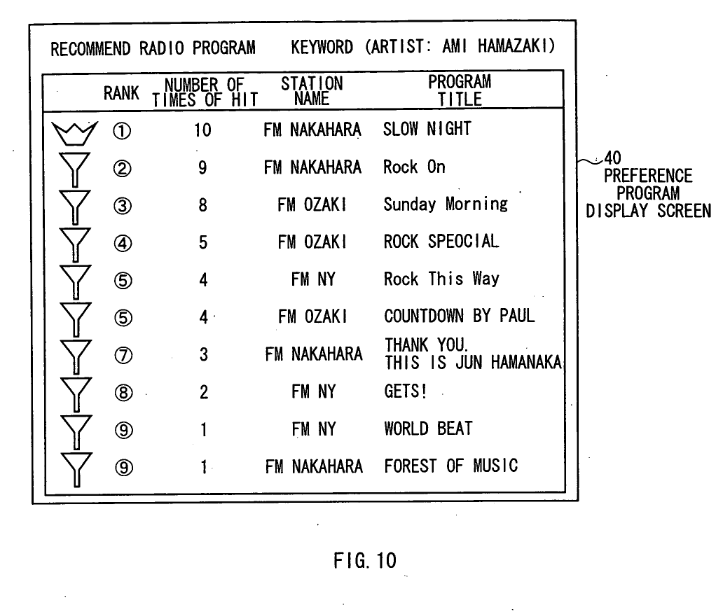

As shown in FIG. 9, the first preference program display processing is formed by a processing sequence by the client terminal 2 and the broadcast content information provision server PS (PS₁-PSₙ). The processing sequence will be described.

For example, if the power is turned on for the first time, at step SP1, the client terminal 2 displays a message to direct the user to enter a keyword showing his/her preference on the display 26. If recognizing that the keyword (for example, artist: “Ami Hamazaki”) was entered responding to this, the client terminal 2 records the keyword (artist: “Ami Hamazaki”) on the hard disk drive 31, and proceeds to the next step SP2.

At step SP2, the client terminal 2 displays a message to direct to specify a period and a cycle acquiring on-air information, on the display 26. If recognizing that for example the acquisition period “November 1-December 31”, the acquisition cycle “1 day” were entered responding to this, the client terminal 2 records them on the hard disk drive 31, and proceeds to the next step SP3.

At step SP3, the client terminal 2 awaits until the date becomes in the acquisition period “November 1-December 31”, based on a clock circuit (not shown) built in itself. If recognizing that the date became in the acquisition period, the client terminal 2 proceeds to the next step SP4.

At step SP4, after the acquisition cycle “1 day” passed, the client terminal 2 requests on-air information for the acquisition cycle “1 day”, from each of the addresses of the broadcast content information provision servers PS (PS₁-PSₙ) that have been recorded as preset information.

When the acquisition cycle has been set to “1 day” as the above, the client terminal 2 requests on-air information for the day before from each broadcast content information provision server PS (PS₁-PSₙ), at the timing that the date changed.

At step SP5, each broadcast content information provision server PS (PS₁-PSₙ) which was requested the on-air information corresponding to the acquisition cycle (in this case, the on-air information for the day before) from the client terminal 2 respectively searches the broadcast content information database 14 for the on-air information for the day before, and proceeds to the next step SP6.

At step SP6, each broadcast content information provision server PS (PS₁-PSₙ) transmits the on-air information for the day before that was obtained as the search result at step SP5 to the client terminal 2.

If receiving the on-air information for the day before transmitted from each broadcast content information provision server PS (PS₁-PSₙ), at step SP7, the client terminal 2 stores this in an on-air information database previously constructed in the hard disk drive 31, and proceeds to the next step SP8. As a result, on-air information concerning the radio programs and the musical compositions that were broadcasted by each radio station RS (RS₁-RSₙ) is stored in the on-air information database.

At step SP8, the client terminal 2 searches the on-air information database for on-air information including the keyword (artist: “Ami Hamazaki”), and proceeds to the next step SP9.

At step SP9, the client terminal 2 groups the on-air information including the keyword (artist: “Ami Hamazaki”) that was obtained as the search result at step SP8 by program titles, and also totalizes the grouped number (that is, it is the appearance frequency of the keyword by the program titles, and hereinafter, this is referred to as the number of hits) by the program titles.

Practically, if it is assumed that for example, the on-air information concerning the radio program in that a song of the artist “Ami Hamazaki” registered as the keyword was broadcasted five times was searched from the on-air information database at the time, the number of hits in the above radio program is “5”. Therefore, the more the radio program in that the number of hits is larger, it can be said to be a radio program having a strong tendency to provide information concerning the keyword, that is, a radio program more matching to the user's preference (a preference program).

Then, the client terminal 2 generates information in that the title of the radio program (preference program), the number of hits of the keyword in the above radio program, and the station name of the radio station RS (RS₁-RSₙ) broadcasting the above radio program are respectively connected with each other (hereinafter, this is referred to as preference program information), based on the obtained on-air information, and proceeds to the next step SP10.

At step SP10, the client terminal 2 determines whether or not the display of preference program information was requested via the operation input section 20 (FIG. 8). If obtaining a negative result here, the client terminal 2 proceeds to step SP12 at this time. On the contrary, if obtaining an affirmative result, the client terminal 2 proceeds to the next step SP11.

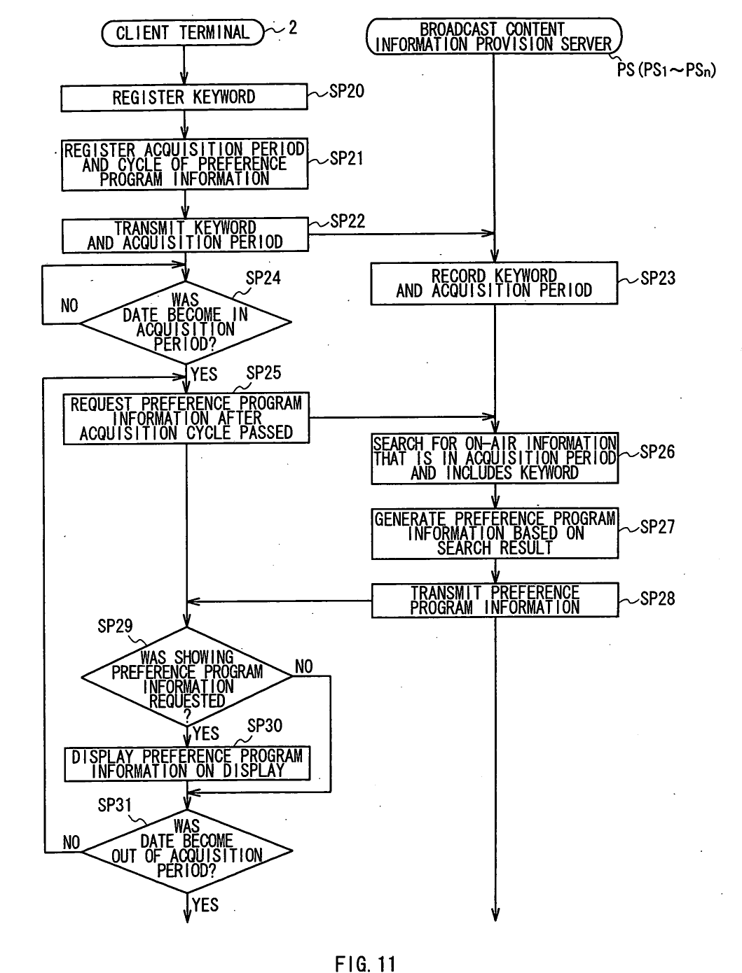

At step SP11, as shown in FIG. 10, the client terminal 2 displays a preference program display screen 40 showing the preference program information on the display 26 (FIG. 8), and proceeds to the next step SP12.

In the preference program display screen 40, the preference program information of the top ten programs in that the number of hits was the largest is displayed in a descending order of the larger number of hits. Thereby, the user can recognize that which radio program by which station is the radio program having a strong tendency to provide information concerning the keyword, that is, which radio program is a radio program matching to the user's preference.

At step SP12, the client terminal 2 determines whether or not the date at the time is in the acquisition period “November 1-December 31”.

If a negative result is obtained here, it means that the date at the time is still in the acquisition period of the on-air information. Thus, the client terminal 2 returns to step SP4, and after the acquisition cycle “1 day” passed again, the client terminal 2 requests the on-air information for the acquisition cycle (for the day before) from each broadcast content information provision server PS (PS₁-PSₙ).

In this manner, the client terminal 2 acquires the on-air information for the acquisition cycle (for the day before) every time when the acquisition cycle “1 day” passed, until an affirmative result is obtained at this step SP12, that is, until the date becomes out of the acquisition period “November 1-December 31”, and stores this in the on-air information database. The client terminal 2 searches the stored on-air information for a preference program, and generates preference program information.

After the affirmative result was obtained at this step SP12, the client terminal 2 stops the acquisition of the on-air information. The client terminal 2 searches the on-air information accumulated in the acquisition period for a preference program, and generates preference program information.

In this manner, in the first preference program display processing, the client terminal 2 acquires the on-air information from the broadcast content information provision server PS (PS₁-PSₙ), searches the on-air information for a preference program based on the keyword and generates preference program information, and displays it on the display 26. Thereby, a radio program matching to the user's preference can be shown to the above user.

(1-4-2) Second Preference Program Display Processing in the Case Where a Preference Program is Searched from On-Air Information on the Broadcast Content Information Provision Server PS (PS₁-PSₙ) Side and the Client Terminal 2 Receives This

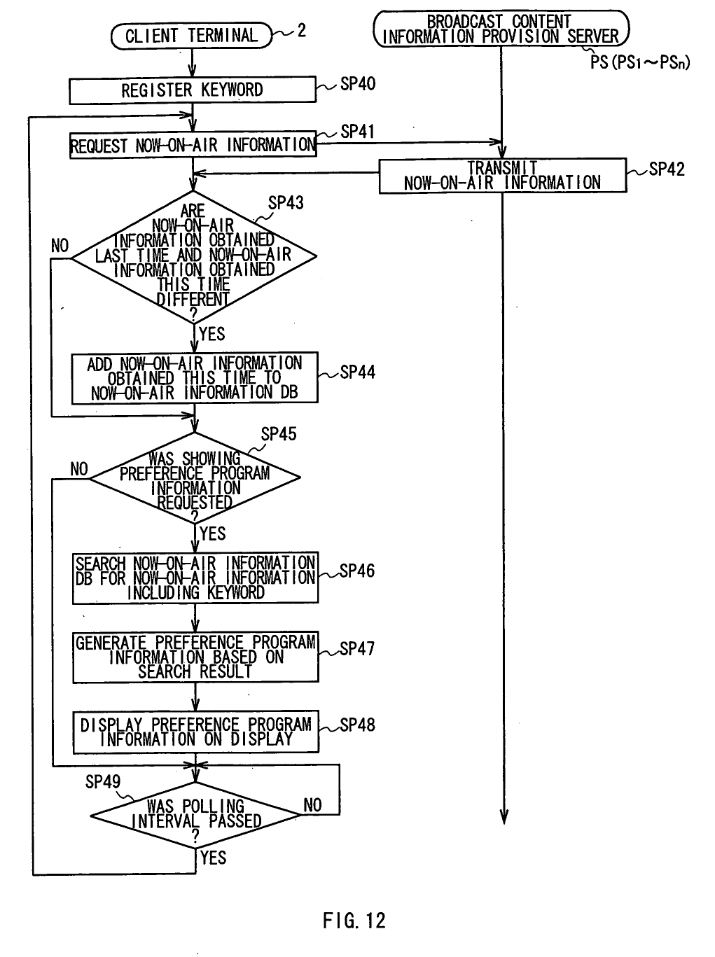

As shown in FIG. 11, the second preference program display processing is formed by a processing sequence by the client terminal 2 and the broadcast content information provision server PS (PS₁-PSₙ). The processing sequence will be described.

For example, if the power is turned on for the first time, at step SP20, the client terminal 2 displays a message to direct the user to enter a keyword showing his/her preference on the display 26. If recognizing that the keyword (for example, artist: “Ami Hamazaki”) was entered responding to this, the client terminal 2 records the keyword (artist: “Ami Hamazaki”) on the hard disk drive 31, and proceeds to the next step SP21.

At step SP21, the client terminal 2 displays a message to direct to specify a period and a cycle acquiring preference program information on the display 26. If recognizing that for example the acquisition period “November 1-December 31”, and the acquisition cycle “1 day” were entered responding to this, the client terminal 2 records them on the hard disk drive 31, and proceeds to the next step SP22.

At step SP22, the client terminal 2 transmits the keyword (artist: “Ami Hamazaki”) and the acquisition period “November 1-December 31” as search condition information, to each of the addresses of the broadcast content information provision servers PS (PS₁-PSₙ) that have been recorded as preset information.

At step SP23, each broadcast content information provision server PS (PS₁-PSₙ) which received the keyword and search condition information (the acquisition period) transmitted from the client terminal 2 records the keyword and the search condition information (the acquisition period) in a RAM 13.

After the client terminal 2 transmitted the keyword and the search condition information (the acquisition period) to each broadcast content information provision server PS (PS₁-PSₙ) at step SP22, the client terminal 2 proceeds to step SP24. At step SP24, the client terminal 2 awaits until the date becomes in the acquisition period of the search condition information “November 1-December 31”, based on a clock circuit (not shown) built in itself. If recognizing that the date became in the acquisition period, the client terminal 2 proceeds to the next step SP25.

At step SP25, after the acquisition cycle “1 day” passed (that is, if the date changed), the client terminal 2 requests preference program information from each of the addresses of the broadcast content information provision servers PS (PS₁-PSₙ) that have been recorded as preset information.

At step SP26, each broadcast content information provision server PS (PS₁-PSₙ) which was requested preference program information from the client terminal 2 respectively reads the keyword and the search condition information (the acquisition period) from the RAM 13, searches the broadcast content information database 14 for on-air information that is in the acquisition period of the above search condition information “November 1-December 31” and including the keyword (artist: “Ami Hamazaki”), and proceeds to the next step SP27.

In this case, each broadcast content information provision server PS (PS₁-PSₙ) searches the broadcast content information database 14 for the on-air information including the keyword (artist: “Ami Hamazaki”) in the on-air information for “November 1-the day before”.

At step SP27, each broadcast content information provision server PS (PS₁-PSₙ) groups the on-air information that was obtained as the search result at step SP26 by program titles, and also totalizes the grouped number (the number of hits of the keyword) by the program titles.

Then, each broadcast content information provision server PS (PS₁-PSₙ) generates preference program information in that the title of the radio program (preference program), the number of hits of the keyword in the above radio program, and the own station name are respectively connected with each other, based on the obtained on-air information, and proceeds to the next step SP28.

At step SP28, each broadcast content information provision server PS (PS₁-PSₙ) transmits the respectively-generated preference program information to the client terminal 2.

If receiving the preference program information transmitted from each broadcast content information provision server PS (PS₁-PSₙ), at step SP29, the client terminal 2 determines whether or not the display of preference program information was requested via the operation input section 20.

If obtaining a negative result here, the client terminal 2 proceeds to step SP31 at this time. On the contrary, if obtaining a negative result, the client terminal 2 proceeds to the next step SP30.

At step SP30, similarly to the case of the first preference program information display processing, the client terminal 2 displays a preference program display screen 40 (FIG. 10) on the display 26, and proceeds to the next step SP31.

Thereby, the user can recognize that which radio program by which station is a radio program having a strong tendency to provide information concerning the keyword, that is, which radio program is a radio program matching to the user's preference.

At step SP31, the client terminal 2 determines whether or not the date is out of the acquisition period “November 1-December 31”.

If a negative result is obtained here, it means that the date at the time is still in the acquisition period of preference program information. Thus, the client terminal 2 returns to step SP25, and after the acquisition cycle “1 day” passed again, the client terminal 2 requests preference program information from each broadcast content information provision server PS (PS₁-PSₙ).

In this manner, the client terminal 2 acquires preference program information every time when the acquisition cycle “1 day” passed, until an affirmative result is obtained at this step SP31, that is, until the date becomes out of the acquisition period “November 1-December 31”.

After the affirmative result was obtained at this step SP31, the client terminal 2 stops the acquisition of preference program information, and displays the preference program information that was obtained last.

In this manner, in the second preference program display processing, the client terminal 2 makes the broadcast content information provision server PS (PS₁-PSₙ) side search on-air information for a preference program and generate preference program information, and receives and displays this on the display 26. Thereby, a radio program matching to the user's preference can be shown to the above user.

(1-4-3) Third Preference Program Display Processing in the Case Where the Client Terminal 2 Searches Now-On-Air Information for a Preference Program

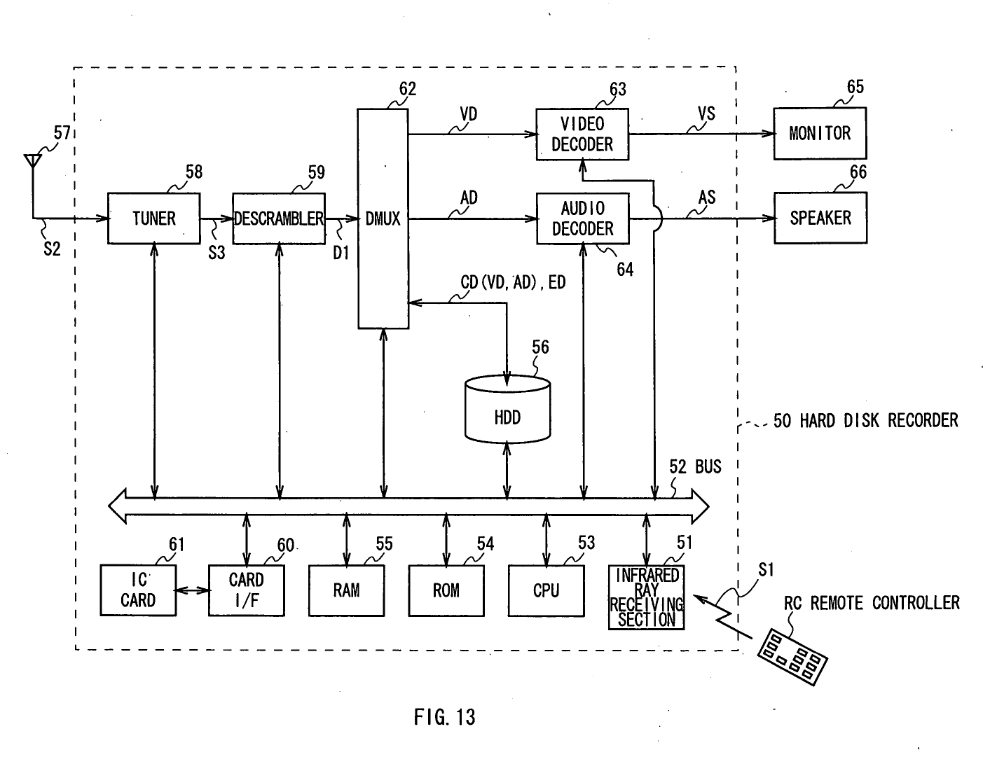

As shown in FIG. 12, the third preference program display processing is formed by a processing sequence by the client terminal 2 and the broadcast content information provision server PS (PS₁-PSₙ). The processing sequence will be described.

Note that, to always acquire the latest now-on-air information, the client terminal 2 makes the acquisition request of now-on-air information to each broadcast content information provision server PS (PS₁-PSₙ) every predetermined interval (hereinafter, this is referred to as a polling interval, and is set to 30 seconds for example).

For example, if the power is turned on for the first time, at step SP40, the client terminal 2 outputs a message to direct the user to enter a keyword showing his/her preference from the display 26. If recognizing that the keyword (for example, artist: “Ami Hamazaki”) was entered responding to this, the client terminal 2 records the keyword (artist: “Ami Hamazaki”) on the hard disk drive 31, and proceeds to the next step SP41.

At step SP41, the client terminal 2 requests now-on-air information from each of the adresses of the broadcast content information provision servers PS (PS₁-PSₙ) that have been recorded as preset information.

At step SP42, each broadcast content information provision server. PS (PS₁-PSₙ) that was requested now-on-air information from the client terminal 2 extracts now-on-air information from the table of program being broadcasted TB1 in the broadcast content information database 14 respectively, and transmits this to the client terminal 2.

If receiving the now-on-air information transmitted from each broadcast content information provision server PS (PS₁-PSₙ), at step SP43, the client terminal 2 compares the received now-on-air information with the now-on-air information that was received from each broadcast content information provision server PS (PS₁-PSₙ) at the last time, and determines whether or not they are different.

Specifically, the client terminal 2 compares the now-on-air information received at this time with the now-on-air information received at the last time for every broadcast content information provision server PS (PS₁-PSₙ). That is, in this case, the now-on-air information received at this time for example from the broadcast content information provision server PS₁ is compared with the now-on-air information received at the last time from the above broadcast content information provision server PS₁.

If a negative result is obtained here, this means that for example in the radio station RS₁ corresponding to the broadcast content information provision server PS₁, the musical composition has not been switched between the present time and the last time (30 seconds ago), and the now-on-air information is the same between the last time and this time. At this time, the client terminal 2 proceeds to step SP45.

On the contrary, if an affirmative result is obtained at step SP43, this means that for example in the radio station RS₁ corresponding to the broadcast content information provision server PS₁, the musical composition was switched between the present time and the last time (30 seconds ago), so that the now-on-air information at the last time and the now-on-air information at this time are different. At this time, the client terminal 2 proceeds to step SP44.

At step SP44, the client terminal 2 adds the now-on-air information acquired at this time to a now-on-air information database that has been previously constructed in the hard disk drive 31, by connecting with the time at the time, and proceeds to the next step SP45.

In this manner, in the client terminal 2, the now-on-air information received from each broadcast content information provision server PS (PS₁-PSₙ) is compared with the now-on-air information received from each broadcast content information provision server PS (PS₁-PSₙ) at the last time respectively, and only when they are different (that is, the musical composition was switched), the now-on-air information is added to the now-on-air information database and is stored.

That is, in the now-on-air information database, now-on-air information concerning the radio program and the musical composition broadcasted by each radio station RS (RS₁-RSₙ) is stored. As a result, in the now-on-air information database, information almost equal to the aforementioned on-air information database is stored.

Therefore, the now-on-air information stored in the now-on-air information database becomes a list showing that which musical composition was broadcasted in which radio program.

At step SP45, the client terminal 2 determines whether or not the display of preference program information was requested via the operation input section 20 (FIG. 8). If obtaining a negative result here, the client terminal 2 proceeds to step SP49 at this time. On the contrary, if obtaining an affirmative result, the client terminal 2 proceeds to the next step SP46.

At step SP46, the client terminal 2 searches the now-on-air information database for now-on-air information including the keyword (artist: “Ami Hamazaki”), and proceeds to the next step SP47.

At step SP47, the client terminal 2 groups the now-on-air information including the keyword (artist: “Ami Hamazaki”) that was obtained as the search result at step SP46 by program titles, and also totalizes the grouped number (the number of hits of the keyword) by the program titles.

Then, the client terminal 2 generates preference program information in that the title of the radio program (preference program), the number of hits of the keyword in the above radio program, and the station name of the radio station RS (RS₁-RSₙ) broadcasting the above radio program are respectively connected with each other, based on the obtained now-on-air information, and proceeds to the next step SP48.

At step SP48, the client terminal 2 displays the preference program display screen 40 (FIG. 10) on the display 26, similarly to the case of the first and the second preference program information display processing, and proceeds to the next step SP49.

Thereby, the user can recognize that which radio program by which station is a radio program having a strong tendency to provide information concerning the keyword, that is, which radio program is a radio program matching to the user's preference.

At step SP49, the client terminal 2 determines whether or not a polling interval (30 seconds) passed from when the client terminal 2 requested now-on-air information from each broadcast content information provision server PS (PS₁-PSₙ) at step SP41, based on the clock circuit (not shown) built in itself.

If obtaining a negative result here, the client terminal 2 awaits until the polling interval passes at this step SP49. After the polling interval passed and an affirmative result was obtained, the client terminal 2 returns to step SP41 again, and requests now-on-air information from each broadcast content information provision server PS (PS₁-PSₙ).

In this manner, the client terminal 2 receives now-on-air information from each broadcast content information provision server PS (PS₁-PSₙ) every polling interval, and stores this in the now-on-air information database only when the above now-on-air information is different from the now-on-air information received at the last time.

Then, the client terminal 2 searches the stored now-on-air information for a preference program based on the keyword and generates preference program information, and displays this on the display 26. Thereby, a radio program matching to the user's preference can be shown to the above user.

(1-5) Operation and Effect in First Embodiment

According to the above configuration, the client terminal 2 makes the user enter a keyword showing the user's preference and the acquisition period of on-air information, and registers them.

Further, the client terminal 2 receives on-air information from the broadcast content information provision servers PS (PS₁-PSₙ) registered as preset information, and stores this in the on-air information database.

Then, the client terminal 2 searches the on-air information database for on-air information that is in the acquisition period and includes the keyword, groups this by the titles of radio programs and totalizes the number of hits of the keyword, and generates preference program information based on the above number of hits of the keyword and displays it.

Thereby, by the client terminal 2, the user can recognize that which radio program by which station is a radio program in that the number of times of hit of the keyword is larger and that has a strong tendency to provide information concerning the above keyword. As a result, a radio program matching to the user's preference can be shown to the above user.

Also, the client terminal 2 transmits the keyword and the acquisition period of on-air information to the broadcast content information provision server PS (PS₁-PSₙ) registered as preset information, and receives preference program information that was generated by each broadcast content information provision server PS (PS₁-PSₙ) based on them.

In this case, each broadcast content information provision server PS (PS₁-PSₙ) searches the broadcast content information database 14 for on-air information that is in the acquisition period and includes the keyword, based on the keyword and the acquisition period of the on-air information transmitted from the client terminal 2, generates preference program information based on the search result, and transmits this to the client terminal 2.

Thereby, processing on the client terminal 2 side can be reduced. Further, that the user of the client terminal 2 likes what radio program can be recognized in each broadcast content information provision server PS (PS₁-PSₙ).

Furthermore, the client terminal 2 also receives now-on-air information that is the broadcast content information being broadcasted, from each broadcast content information provision server PS (PS₁-PSₙ), instead of the on-air information that is broadcast content information already broadcasted stores this, and generates preference program information based on the stored now-on-air information.

By generating preference program information based on the now-on-air information being the broadcast content information being broadcasted now as the above, preference program information which was generated based on the latest broadcast content information can be provided to the user.

According to the above configuration, the client terminal 2 registers a keyword showing the user's preference in radio programs, totalizes the number of hits of the above keyword in each radio program based on on-air information and now-on-air information, and displays the number of hits of the keyword on the display 26. Thereby, the user can recognize that which radio program is a radio program having a strong tendency to provide information concerning the keyword. Thus, a radio program matching to the user's preference can be shown to the above user.

Furthermore, by totalizing the number of hits of the keyword in each radio program and displaying it as the above, the user can recognize that each radio program matches to the above user's preference in how degree.

Further, the client terminal 2 displays the ranking of the top ten programs in that the number of hits of the keyword is the largest on the display 26 to show it to the user. Thereby, the above user can easily recognize that which radio program is a radio program having a strong tendency to provide information concerning the keyword.

### (2) Second Embodiment

(2-1) Configuration of Hard Disk Recorder

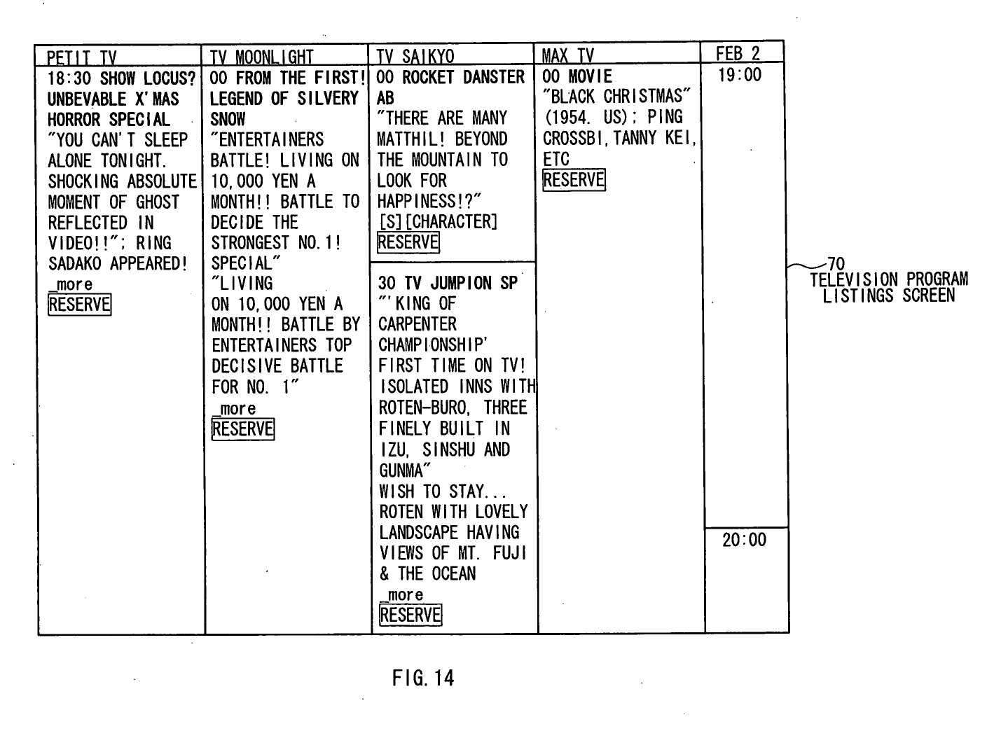

Referring to FIG. 13, the reference numeral 50 shows a hard disk recorder according to this embodiment as a whole. The hard disk recorder 50 receives various commands transmitted from a remote controller RC as infrared ray signals S1 according to the operation of the remote controller RC, by an infrared ray receiving section 51, and supplies this to a CPU 53 via a bus 52.

The CPU 53 reads out various programs such as a basic program and application programs previously stored in a ROM 54 to a RAM 55 via the bus 52, and controls the entire client terminal 2 according to these various programs, and also executes processing corresponding to the various commands supplied from the infrared ray receiving section 51.

In the hard disk recorder 50, a hard disk drive 56 of for example 250 GB degree has been built in. In addition to a normal mode to output program video and program sound in a television program by television broadcasting received via an antenna 57, it has a recording mode to record video data and audio data based on the program video and the program sound on the hard disk drive 56, and a reproducing mode to read and reproduce the recorded video data and audio data.

In the normal mode, the CPU 53 inputs a television broadcast wave S2 received via the antenna 57 to a tuner 58.

The tuner 58 extracts a signal on a channel specified via the remote controller RC (hereinafter, this is referred to as a television signal) S3, from the television broadcast wave S2, and transmits this to a descrambler 59, under the control of the CPU 53.

The descrambler 59 performs predetermined descramble processing on the television signal S3, by using cipher key information that has been recorded in an IC card 61 inserted into a card interface 60, and transmits thus obtained television broadcast data D1 to a demultiplexer 62, under the control of the CPU 53.

The demultiplexer 62 separates the television broadcast data D1 into video data VD composed of video packets and audio data AD composed of audio packets, and transmits the video data VD to a video decoder 63 and also transmits the audio data AD to an audio decoder 64, under the control of the CPU 53.

The video decoder 63 performs predetermined decoding processing based on the Moving Picture Experts Group (MPEG) standard on the video data VD and performs digital-to-analog conversion, and transmits thus obtained video signal VS to an external monitor 65, under the control of the CPU 53.

On the other hand, the audio decoder 64 performs predetermined decoding processing based on the MPEG standard on the audio data AD and performs digital-to-analog conversion, and transmits thus obtained audio signal AS to an external speaker 66, under the control of the CPU 53.

Thereby, program video based on the video signal VS is displayed on the external monitor 65, and program sound based on the audio signal AS is emitted from the external speaker 66.

In this manner, in the normal mode, the hard disk recorder 50 can make the user view program video and program sound in a television program on a channel specified by the user, via the monitor 65 and the speaker 66.

Further, in the recording mode, the CPU 53 performs predetermined processing on the television broadcast wave S2 received via the antenna 57 in the tuner 58, the descrambler 59 and the demultiplexer 62, similarly to the normal mode. Thereby, the CPU 53 obtains video data VD and audio data AD, and transmits them to the hard disk drive 56.

The hard disk drive 56 records the video data VD, and the audio data AD corresponding to the above video data VD in an empty area as program contents data CD.

In this manner, in the recording mode, the hard disk recorder 50 can record program contents data CD based on program video and program sound by television broadcasting on the hard disk drive 56.

Furthermore, in the reproducing mode, the CPU 53 reads out program contents data CD that was specified to be reproduced via the remote controller RC from the hard disk drive 56, and transmits this to the demultiplexer 62.

The demultiplexer 62 transmits the video data VD being the video part of the program contents data CD to the video decoder 63, and also transmits the audio data AD being the audio part of the above program contents data CD to the audio decoder 64, under the control of the CPU 53.

Then, the CPU 53 performs predetermined processing on the video data VD and the audio data AD in the video decoder 63 and the audio decoder 64 respectively to obtain a video signal VS and an audio signal AS, similarly to the normal mode, and transmits them to the monitor 65 and the speaker 66 respectively.

In this manner, in the reproducing mode, the hard disk recorder 50 can make the user view program video and program sound based on the program contents data CD recorded in the hard disk via the monitor 65 and the speaker 66.

Also, in the demultiplexer 62, when the video data VD and the audio data AD are separated from the television broadcast data D1, the CPU 53 also separates data of electronic program guide information included in the television broadcast data D1 together with them (hereinafter, this is referred to as electronic program guide (EPG) data) ED, and records this on the hard disk drive 56.

This EPG data ED has been described in a table form in a section format referred to as service information (SI). In this table form, a service description table (SDT) which shows information on channels, and an event information table (EIT) which shows information on television programs exist.

In this SDT, the channel number, the channel name (broadcasting station name), the contents of the channel or the like have been described. In the EIT, the title of the television program, the broadcasting start time, the broadcasting end time, the genre, the story, or the like have been described.

That is, in the EPG data ED, information concerning the television programs that will be broadcasted from the present time to dozens of hours hence (hereinafter, this is referred to as television broadcast content information) has been described. It is frequently distributed from the broadcasting station at predetermined timing. Therefore, in the hard disk drive 56, the latest EPG data ED is always held.

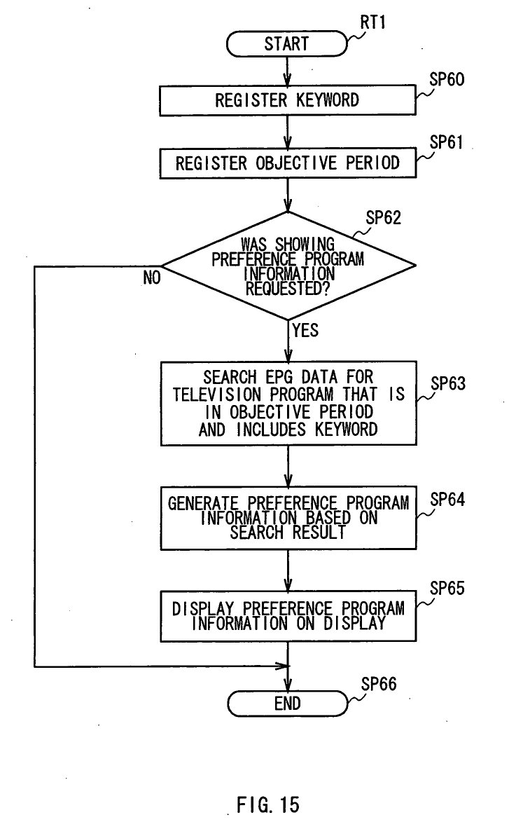

Then, the CPU 53 generates television program listings data by means of the EPG data ED, and displays this on the monitor 65 via the video decoder 63 as a television program listings screen 70 (FIG. 14).

In this television program listings screen 70, the television broadcast content information of the television programs that will be broadcasted from the present time to dozens of hours hence is displayed in a list by channels. Thus, the user can confirm the television broadcast content information concerning each television program on each channel that will be broadcasted from the present time to dozens of hours hence on the television program listings screen 70.

Furthermore, in the hard disk recorder 50, the user can select a television program wanting to record via the remote controller RC on the television program listings screen 70. Thereby, the reserve-recording of the television program selected by the user can be performed.

(2-2) Preference Program Display Function

The hard disk recorder 50 according to this embodiment has a preference program display function to search for a television program matching to the user's preference (hereinafter, this is also referred to as a preference program) and show this to the user.

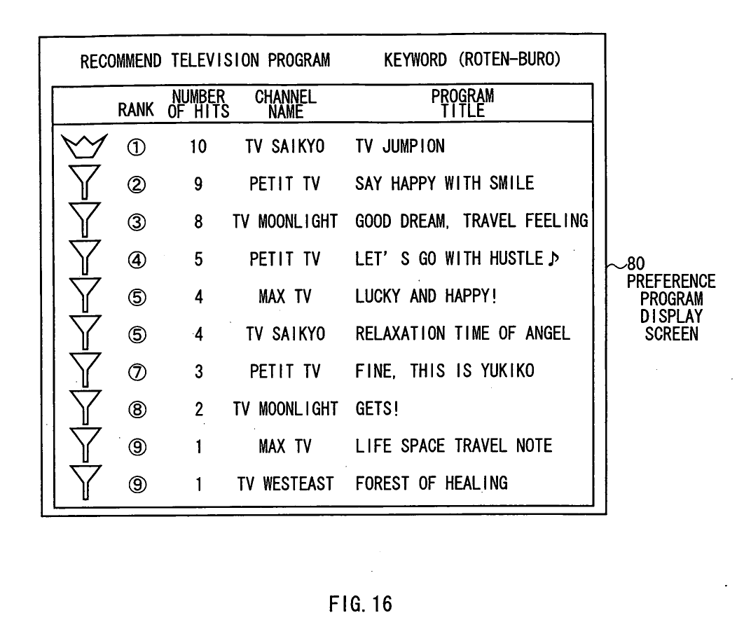

Practically, the hard disk recorder 50 searches EPG data ED for the preference program. Preference program display processing in this preference program display function will be described with reference to FIG. 15.

For example, if the power is turned on for the first time, the CPU 53 of the hard disk recorder 50 starts a preference program display processing routine RT1. At the next step SP60, the CPU 53 displays a message to direct the user to enter a keyword showing his/her preference on the monitor 65. If recognizing that the keyword (for example, “roten-buro”) was entered via the remote controller RC responding to this, the CPU 53 records this keyword “roten-buro” on the hard disk drive 56, and proceeds to the next step SP61.

At step SP61, the CPU 53 displays a message to direct to specify an objective period showing that which period in the EPG data ED should be set as the search objective period of a preference program on the monitor 65. If recognizing that for example an objective period “January 1-February 28” was entered responding to this, the CPU 53 records this on the hard disk drive 56, and proceeds to the next step SP62.

At step SP62, the CPU 53 determines whether or not the display of preference program information was requested via the remote controller RC. If obtaining a negative result here, the CPU 53 proceeds to step SP66 at this time. On the contrary, if obtaining an affirmative result, the CPU 53 proceeds to the next step SP63.

At step SP63, the CPU 53 reads out the keyword “roten-buro” and the objective period “January 1-February 28” from the hard disk drive 56, searches the EPG data ED recorded in the hard disk drive 56 for television broadcast content information that is in the objective period “January 1-February 28” and includes the keyword “roten-buro”, and proceeds to the next step SP64.

At step SP64, the CPU 53 groups the television broadcast content information that was obtained as the search result at step SP63 by the titles of television programs, and also totalizes the grouped number (the number of hits of the keyword) by the titles.

Then, the CPU 53 generates preference program information in that the title of the television program (preference program), the number of hits of the keyword in the above television program, and the channel name broadcasting the above television program have been respectively connected with each other, based on the obtained television broadcast content information, and proceeds to the next step SP65.

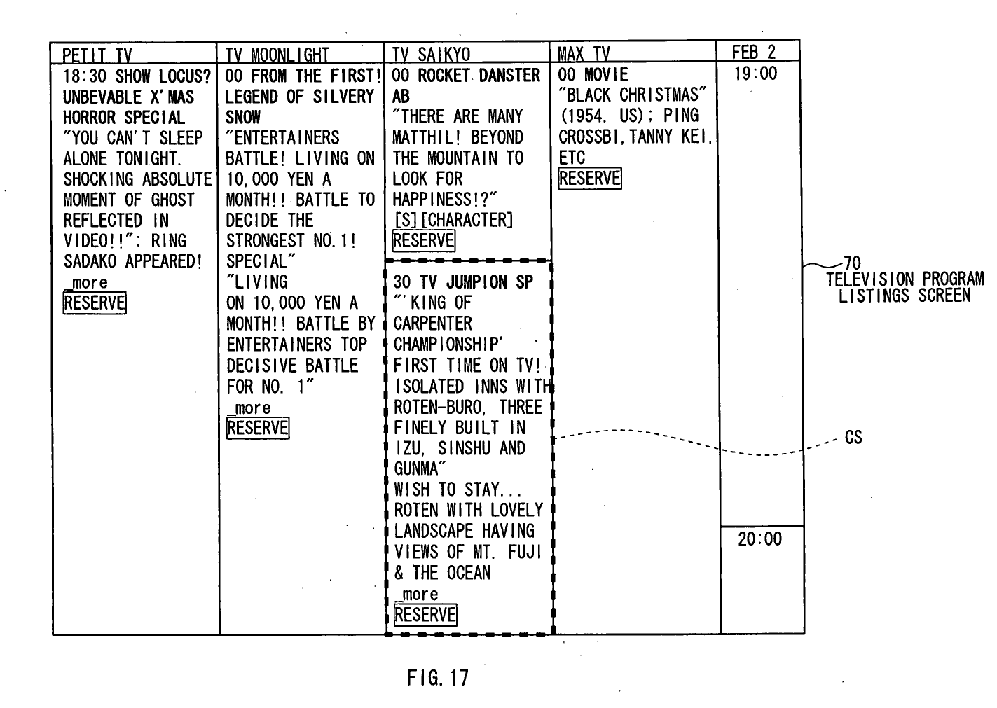

At step SP65, as shown in FIG. 16, the CPU 53 displays a preference program display screen 80 showing the preference program information on the monitor 65.

In the preference program display screen 80, the preference program information of the top ten programs in that the number of hits was the largest is displayed in a descending order of the larger number of hits. Thereby, the user can recognize that which television program on which channel is a television program having a strong tendency to provide information concerning the keyword, that is, which television program is a television program matching to the user's preference.

After displayed the preference program display screen 80 as the above, the CPU 53 proceeds to the next step SP66 to finish the preference program display processing.

In this manner, in the preference program display processing, the hard disk recorder 50 searches the EPG data ED for a preference program based on the keyword, generates preference program information, and displays this on the monitor 65. Thereby, a television program matching to the user's preference can be shown to the above user.

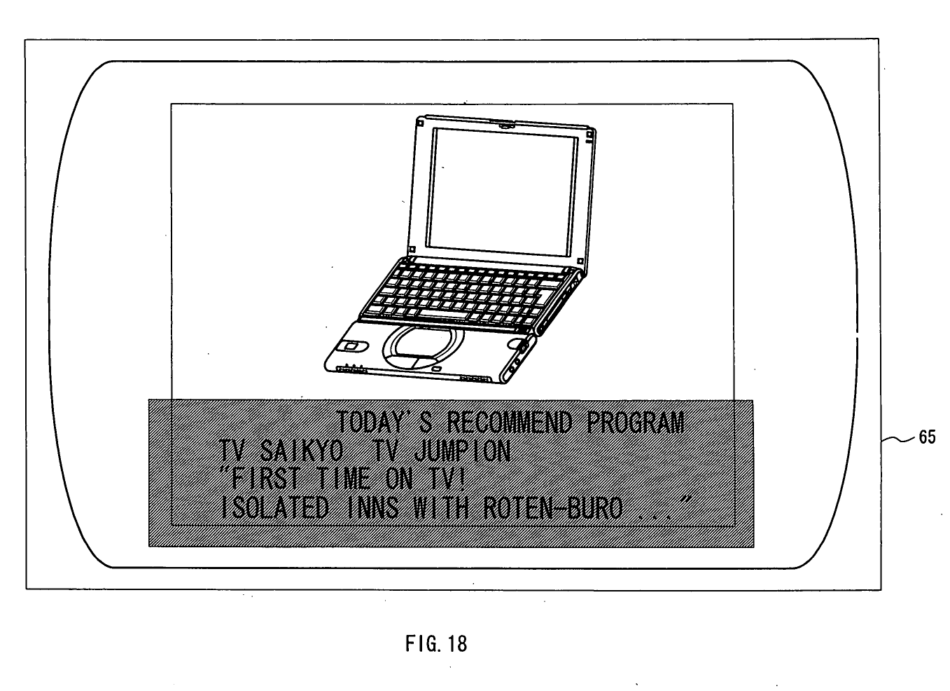

Further, if recognizing a television program matching to the user's preference in the preference program display processing, for example, as shown in FIG. 17, the CPU 53 displays a cursor CS in coming on and off at the display position of the above television program on the television program listings screen 70. Thereby, when the user refers to the television program listings screen 70, the user can recognize that which television program is a television program matching to the preference of the above user.

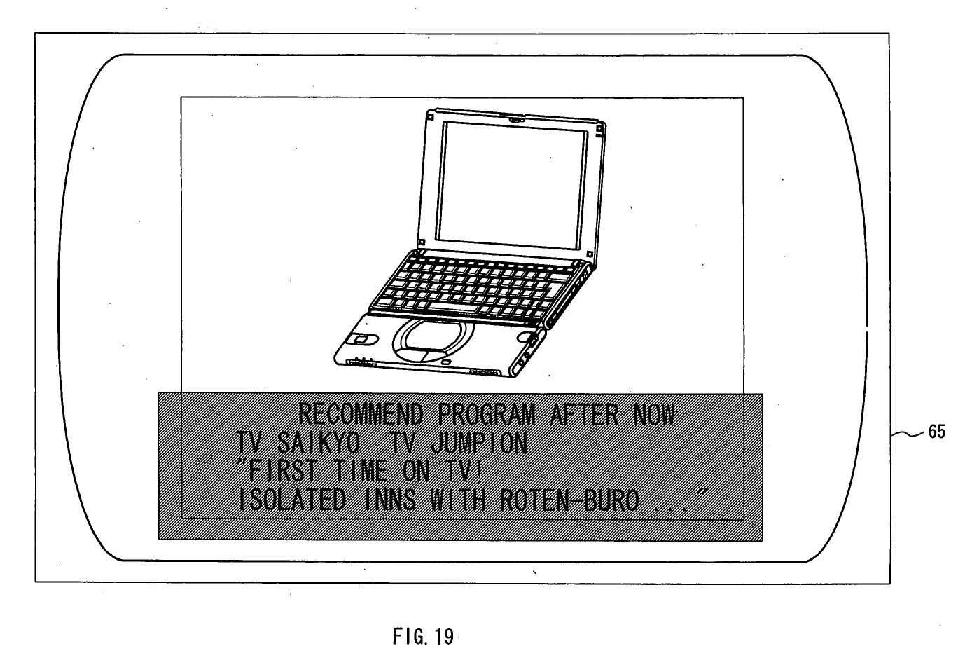

Further, when the mode was switched to the normal mode for viewing a television program, for example, as shown in FIG. 18, the CPU 53 displays the title of the television program that will be broadcasted on the day on the monitor 65, among the television programs in that the number of hits was larger. Thereby, that a television program matching to the user's preference will be broadcasted on the day can be notified the above user.

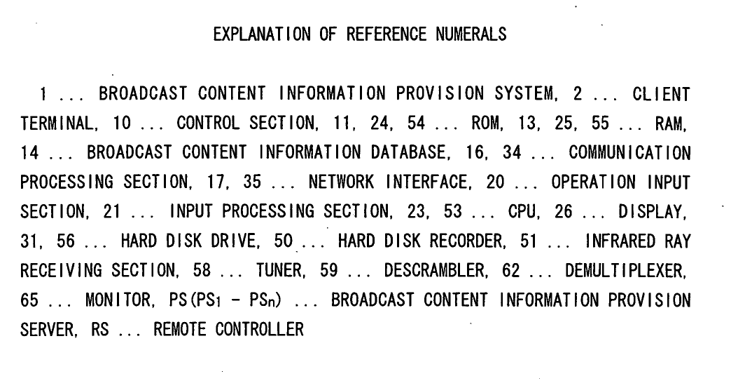

Further, just before the television program being outputted in the normal mode will be finished, for example, as shown in FIG. 19, the CPU 53 displays the title of a television program that will be broadcasted after the finish of the television program being outputted on the monitor 65, among the television programs in that the number of hits was larger. Thereby, that a television program matching to the user's preference will be broadcasted after the finish of the viewing television program can be notified the above user.

(2-3) Operation and Effect in the Second Embodiment

According to the above configuration, the hard disk recorder 50 makes the user enter a keyword showing the user's preference and the objective period of EPG data ED, and registers them.

Then, the hard disk recorder 50 searches the EPG data ED for television broadcast content information that is in this objective period and includes the keyword, groups this by the titles of television programs and totalizes the number of hits of the keyword, and generates and displays preference program information based on the above number of hits of the keyword.

Thereby, the hard disk recorder 50 can make the user recognize that which television program on which channel had the larger number of times of hit of the keyword and is a television program having a strong tendency to provide information concerning the above keyword. As a result, a television program matching to the user's preference can be shown to the above user.

According to the above configuration, the hard disk recorder 50 registers a keyword showing the user's preference in television programs, totalizes the number of hits of the above keyword in each television program based on the EPG data ED, and displays the number of hits of the keyword on the monitor 65. Thereby, the user can recognize that which television program is a television program having a strong tendency to provide information concerning the keyword. Thus, a television program matching to the user's preference can be shown to the above user.

Furthermore, by totalizing the number of hits of the above keyword in each radio program and displaying this as the above, the above user can recognize that each television program matches to the user's preference in how degree.

Further, the hard disk recorder 50 displays the ranking of the top ten programs in that the number of hits of the keyword is the largest on the monitor 65, and shows this to the user. Thereby, the above user can easily recognize that which television program is a television program having a strong tendency to provide information concerning the keyword.

As a result, the user can freely select viewing and recording based on the ranking, for example, as that the user will view the television program in that the number of hits was the largest and will record the television program in that the number of hits was the largest secondly. Thus, in the hard disk recorder 50, usefulness in viewing and recording of a television program can be further improved.

### (3) Other Embodiments

In the aforementioned first and second embodiments, it has dealt with the case where radio programs and television programs as broadcasting programs are set as the object of a preference program. However, the present invention is not only limited to this but also various broadcasting programs other than them such as program contents broadcasted on the Internet may be set as the object of a preference program.

In the aforementioned first and second embodiments, it has dealt with the case where respectively-corresponding broadcast content information provision server PS (PS₁-PSₙ) is connected to each radio station RS (RS₁-RSₙ), and broadcast content information of radio broadcasting broadcasted by the radio station RS (RS₁-RSₙ) that respectively corresponds to each broadcast content information provision server PS (PS₁-PSₙ) is recorded and managed. However, the present invention is not only limited to this but also broadcast content information of radio broadcasting broadcasted by all of the radio stations RS (RS₁-RSₙ) may be recorded and managed in a lump, by one broadcast content information provision server connected to the all of the radio stations RS (RS₁-RSₙ), for example.

Further, in the aforementioned first embodiment, it has dealt with the case where in the table of already-broadcasted musical compositions TB2 and the table of already-broadcasted programs TB3 that are the source of on-air information, broadcast content information concerning the radio programs that were broadcasted in the past and the musical compositions that were broadcasted in the above radio program are stored. However, the present invention is not only limited to this but also for example broadcast content information concerning the radio programs that are scheduled to be broadcasted and the musical compositions that are scheduled to be broadcasted in the above radio programs for several weeks may be previously stored. Thereby, for example, it is also possible to search for a radio program matching to the user's preference from among the radio programs that are scheduled to be broadcasted and show this to the above user.

Further, in the aforementioned first embodiment, it has dealt with the case where a radio program matching to the user's preference (preference program) is searched from the on-air information and now-on-air information as broadcast content information that have been held in each broadcast content information provision server PS (PS₁-PSₙ). However, the present invention is not only limited to this but also provided that it is the broadcast content information including information that can specify the user's preference, a preference program may be searched from various broadcast content information other than this.

Further, in the aforementioned second embodiment, it has dealt with the case where a television program matching to the user's preference (preference program) is searched from the EPG data ED as electronic program listings included in the television broadcast wave S2. However, the present invention is not only limited to this but also provided that it is electronic program listings including information capable of specifying the user's preference, a preference program may be searched from various electronic program listings other than this such as EPG data distributed from a server on the Internet.

Further, in the aforementioned first embodiment, it has dealt with the case where the acquisition period of on-air information and now-on-air information (that is, the broadcasting period of a radio program) and the addresses (or the broadcasting station names) of the broadcast content information provision servers PS (PS₁-PSₙ) that have been registered in preset information is set as the search condition of preference program. However, the present invention is not only limited to this but also other information included in on-air information and now-on-air information may be set as a search condition. In this case, by making the user specify the titles of plural radio programs as search conditions, and showing that these specified programs respectively hit the keyword in how degree, the above user also can recognize that these programs are programs matching to the user's preference in how degree.

Further, in the aforementioned second embodiment, it has dealt with the case where the objective period in the EPG data ED (that is, the broadcasting period of a television program) is set as the search condition of preference program. However, the present invention is not only limited to this but also the channel name (the broadcasting station name) of a television program, and the program title of a television program that are included in the EPG data ED may be set as search conditions. In this case, by making the user freely specify these search conditions, a preference program corresponding to a viewing time, a viewing channel, and a viewing program by the user can be searched.

Further, in the aforementioned second embodiment, it has dealt with the case where the preference program display function is provided in the hard disk recorder 50 capable of viewing, recording and reproducing a television program. However, the present invention is not only limited to this but also the preference program display function may be provided in various equipment other than this such as a portable terminal capable of obtaining the EPG data ED.

Further, in the aforementioned first embodiment, it has dealt with the case where the client terminal 2 serving as a program search system, an external device and an information processing unit is composed of the operation input section 20 and the input processing section 21 that serve as keyword registration means and search condition setting means, the communication processing section 34 and the network interface 35 that serve as communication means, and the CPU 23 serving as detection means. However, the present invention is not only limited to this but also the client terminal 2 may be formed by various configurations other than this.

Further, in the aforementioned first embodiment, it has dealt with the case where the broadcast content information provision server PS (PS₁-PSₙ) serving as a program search system, a storage unit and an information processing unit is composed of the broadcast content information database 14 serving as a storage medium, the communication processing section 16 and the network interface 17 that serve as receiving means and transmission means, and the control section 10 serving as search means and detection means. However, the present invention is not only limited to this but also the broadcast content information provision server PS (PS₁-PSₙ) may be formed by various configurations other than this.

Further, in the aforementioned second embodiment, it has dealt with the case where the hard disk recorder 50 serving as a program searching system is composed of the remote controller RC and the infrared ray receiving section 51 that serve as keyword registration means and search condition setting means, the tuner 58, the descrambler 59 and the demultiplexer 62 that serve as program listings receiving means, and the CPU 53 serving as program listings search means and detection means. However, the present invention is not only limited to this but also the hard disk recorder 50 may be formed by various configurations other than this.

Further, in the aforementioned embodiments, radio broadcasting broadcasted by radio stations is applied to the broadcasting that can be received by the client terminal 2, and television broadcasting broadcasted by television stations is applied to the broadcasting that can be received by the hard disk recorder 50. However, the present invention is not only limited to this but also the client terminal 2 may receive Internet radio broadcasting and satellite radio broadcasting and obtain their broadcast content information, or the hard disk recorder 50 may receive Internet television broadcasting and obtain various broadcast content information or the like concerning the television programs by the Internet television broadcasting from a server on the network.

Further, in the aforementioned embodiments, it has dealt with the case where the control section 10 of the broadcast content information provision server PS (PS₁-PSₙ) and the CPU 23 of the client terminal 2 execute the aforementioned preference program display processing based on the programs previously stored in the ROM 11 and the ROM 24. However, the present invention is not only limited to this but also for example, a module dedicated to the preference program display processing may be packaged in the broadcast content information provision server PS (PS₁-PSₙ) and the client terminal 2, and this module may execute the preference program display processing in place of the control section 10 and the CPU 23.

Further, in the aforementioned embodiments, it has dealt with the case where the CPU 53 of the hard disk recorder 50 executes the aforementioned preference program display processing based on the programs previously stored in the ROM 54. However, the present invention is not only limited to this but also for example, the module dedicated to the preference program display processing may be packaged in the hard disk recorder 50, and this module may execute the preference program display processing in place of the CPU 53.

Further, in the aforementioned embodiments, it has dealt with the case where the present invention is applied to the client terminal 2 being a receiving device of radio broadcasting and the hard disk recorder 50 being a receiving device of television broadcasting. However, the present invention is not only limited to this but also may be applied to various terminals other than the client terminal 2 and the hard disk recorder 50, such as a cellular phone and a personal computer. Moreover, in this case, for example, if the aforementioned module dedicated to the preference program display processing is packaged in these terminals, processing similar to the client terminal 2 and the hard disk recorder 50 can be easily realized.

### INDUSTRIAL APPLICABILITY

The present invention can be widely used to a program search system for searching for a broadcast program matching to the user's preference.

1. A program search system comprising:
keyword registration means for registering a keyword for showing the user's preference in broadcast programs;
communication means for receiving broadcast content information including the titles of said broadcast programs that will be broadcasted by one or more broadcasting stations; and
detection means for detecting the appearance frequency of said keyword by said broadcast programs, in the broadcast content information received by said communication means.

2. The program search system according to claim 1, wherein;
said detection means specifies a broadcast program according to the appearance frequency of said keyword.

3. The program search system according to claim 1, wherein;
said detection means generates the ranking of said broadcast programs in the descending order of the higher appearance frequency of said keyword.

4. The program search system according to claim 1, wherein:
search condition setting means for setting at least either one of the broadcasting period, the title and the broadcasting station of said broadcast program as a search condition is further included; and
said communication means transmits request information to request broadcast content information corresponding to said search condition set by said search condition setting means, from a storage device that stores broadcast content information including the broadcasting time and date and the titles of said broadcast programs that will be broadcasted by one or more broadcasting stations by the above broadcast programs, and also receives the broadcast content information transmitted from said storage device responding to the above request information.

5. The program search system according to claim 1, wherein:
said communication means transmits request information to request broadcast content information from a storage device that stores broadcast content information including the title of said broadcast program being broadcasted by one or more broadcasting stations, and also receives the broadcast content information transmitted from said storage device responding to the above request information;
storage means for storing said received broadcast content information is further included; and
said detection means detects the appearance frequency of said keyword by said broadcast programs, in the broadcast content information stored in said storage means.

6. The program search system according to claim 1, wherein:
said communication means receives electronic program listings formed by broadcast content information including the broadcasting time and date and the titles of said broadcast programs that will be broadcasted by one or more broadcasting stations; and
said detection means searches the broadcast content information included in said electronic program listings for broadcast content information including said keyword, and detects the appearance frequency of said keyword by said broadcast programs, in the broadcast content information that was obtained as the search result.

7. A program search system comprising:
a storage medium for storing broadcast content information including the broadcasting time and date and the title of a broadcast program that will be broadcasted by one or more broadcasting stations by the above broadcast programs;
receiving means for receiving search condition information to specify at least either one of the broadcasting period, the title and the broadcasting station name of said broadcast program as a search condition, and a keyword showing the user's preference in said broadcast programs, from an external device;
search means for searching said storage medium for broadcast content information corresponding to said search condition, based on said search condition information received by said receiving means;
detection means for detecting the appearance frequency of said keyword by said broadcast programs, in the broadcast content information that was obtained as the search result by said search means; and
transmission means for transmitting information based on the appearance frequency of said keyword by said broadcast programs detected by said detection means, to said external device.

8. The program search system according to claim 7, wherein;
said detection means generates information to specify a broadcast program, according to the appearance frequency of said keyword.

9. The program search system according to claim 7, wherein;
said detection means generates the ranking of said broadcast programs in the descending order of the higher appearance frequency of said keyword.

10. A program search method comprising:
the keyword registration step of registering a keyword showing the user's preference in broadcast programs;
the communication step of receiving broadcast content information including the titles of broadcast programs that will be broadcasted by one or more broadcasting stations; and
the detection step of detecting the appearance frequency of said keyword by said broadcast programs, in the broadcast content information received in said communication step.

11. A program search method comprising:
the storing step of storing broadcast content information including the broadcasting time and date and the title of a broadcast program that will be broadcasted by one or more broadcasting stations in a storage medium by the above broadcast programs;
the receiving step of receiving search condition information to specify at least either one of the broadcasting period, the title and the broadcasting station name of said broadcast program as a search condition, and a keyword for showing the user's preference in said broadcast programs, from an external device;
the search step of searching said storage medium for broadcast content information corresponding to said search condition, based on said search condition information received in said receiving step;
detection step of detecting the appearance frequency of said keyword by said broadcast programs, in broadcast content information that was obtained as the search result in said search step; and
transmission step of transmitting information based on the appearance frequency of said keyword by said broadcast programs that was detected in said detecting step, to said external device.

12. A program search program to make an information processing unit execute:
the keyword registration step of registering a keyword showing the user's preference in broadcast programs;
the communication step of receiving broadcast content information including the titles of said broadcast programs that will be broadcasted by one or more broadcasting stations; and
the detection step of detecting the appearance frequency of said keyword by said broadcast programs, in the broadcast content information received in said communication step.

13. A program search program to make an information processing unit execute:
the storing step of storing broadcast content information including the broadcasting time and date and the titles of the broadcast programs that will be broadcasted by one or more broadcasting stations in a storage medium, by the broadcast programs;
the receiving step of receiving search condition information to specify at least either one of the broadcasting period, the title and the broadcasting station name of said broadcasting program as a search condition, and a keyword showing the user's preference in said broadcast programs, from an external device;
the search step of searching for broadcast content information corresponding to said search condition from said storage medium, based on said search condition information received in said receiving step;
the detection step of detecting the appearance frequency of said keyword by said broadcast programs, in the broadcast content information that was obtained as the search result in said search step; and
the transmission step of transmitting information based on the appearance frequency of said keyword by said broadcast programs detected in said detection step, to said external device.
